(19) United States
(12) Patent Application Publication
(10) Pub. No.: US 2004/0117264 A1
(43) Pub. Date: Jun. 17, 2004

(54) System and method providing a performance-prediction service with query-program execution

(75) Inventors: David M. Chess, Mohegan Lake, NY (US); John F. Morar, Mahopac, NY (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/317,356

(22) Filed: Dec. 12, 2002

(51) Int. Cl. G06F 17/60

(52) U.S. Cl. 705/26

(57) ABSTRACT

A method and a system provide a service to a customer (101) over a network (102), such as the global Internet, where the service provides the customer access to a database (104). The method includes: (a) receiving a query (101A) from the customer, the query including a query program or an identification of a query program; (b) executing the query program in an environment (103, 105, 106, 107) that permits the query program to access at least a portion of the database while selectively inhibiting transmission of information from the database; and (c) sending a response to the query, where the response includes a predetermined, limited amount of information that is returned as output by the query program. Preferably the amount of information returned in the response to the query is limited to a predetermined number of data units. Sending the response involves examining the information that is returned as output by the query program, and the response is sent only if at least one criterion is satisfied. The criterion in this case can be that the information returned as output by the query program is equal to or less than some maximum number of data units. The query may further include information for specifying what data of the database is relevant to the query, and where the environment allows the query program to access only the specified data. In a presently preferred embodiment the system is a supplier rating system, and the database stores data that is expressive of supplier performance.

### TECHNICAL FIELD

These teachings relate generally to database query systems and methods, as well as to business methods involving networked computer systems and one or more databases.

### BACKGROUND

One potential barrier to online commerce and dynamic electronic business (e-business) is the difficulty of establishing trust between parties that have not interacted before, and that may be acquainted with each other only by virtue of online catalog listings. In the consumer area, organizations such as the Better Business Bureau aid parties to a potential transaction to evaluate one another, and to estimate how likely a transaction is to be successful. In the business-to-business (B2B) area there exist companies that are developing systems to provide a similar type of rating service by gathering and disseminating information, such as customer satisfaction in previous interactions with suppliers.

An important consideration when developing this type of rating service is how to provide useful information to customers, without losing control of the underlying raw data. The raw data may itself be one of the key assets owned by the rating service. Giving customers access to the raw data allows those customers full flexibility in making their evaluations; however, a rating service may be very reluctant to give a customer a copy of the raw data, due to its great value and ease of duplication. On the other hand, providing customers with only a fixed set of calculated summaries of the raw data protects the data, but offers less flexibility and value to the customer. The inventors are unaware of any previous methods or systems that could simultaneously solve both of these problems.

In U.S. Pat. No. 6,026,374, “System and Method for Generating Trusted Descriptions of Information Products”, David M. Chess (a co-inventor of the subject matter of this patent application) describes a system that allows a customer to have a summarizer program connect to a vendor of information goods. The summarizer program is then run and uses search and evaluation methods to generate a score for product(s) of interest to the customer. The score information is relayed back to the customer for enabling the customer to make a determination as to whether the information goods are worth purchasing. In one embodiment there is disclosed a system in which a prospective buyer sends a summarization program to a vendor, and the vendor runs that program in a restricted environment, allowing the program to examine the information products for sale, but not to do anything else to the vendor's system, and strictly filtering (possibly to a single buy/don't buy bit) the communication back from the program to the buyer.

Mobile agent and database query language techniques are well known in the art. Some of these techniques allow a user to send a program from one system to another, to be executed on the other, possibly remote, system. Typically, however, such programs are executed with the privileges and permissions of the sender of the program, and any limitations imposed on the size or content of the returned data are primarily based simply on resource constraints.

### SUMMARY OF THE PREFERRED EMBODIMENTS

The foregoing and other problems are overcome, and other advantages are realized, in accordance with the presently preferred embodiments of these teachings.

This invention provides a technique to simultaneously allow valuable data to be accessible to a query program associated with a user, while being protected against disclosure to and/or copying by that user.

In one aspect this invention provides a computer implemented rating service, also referred to herein as a performance-prediction service or as a supplier performance-prediction service, where the supplier may be supplier of goods and/or services. The computer implemented rating service accepts an executable software module from a customer, also referred to herein as a customer program, and runs the customer program in a controlled environment where the customer program has access to all relevant raw data or a sub-set of the raw data, also referred to herein as supplier-related source data, that is maintained by the rating service. The customer program is, however, not provided with the ability to send a copy of all of the source data back to the customer. Instead, at most only some sub-set of the source data (such as a few bytes) is permitted to be returned to the customer from the customer program. When the processing is completed, the customer program is terminated.

In that the customer selects the program to be sent to the rating service, and further in that the customer program may potentially have read access to all of the source data, the customer is enabled to implement any desired type of source data evaluation algorithm. Because the customer program can send only a very limited amount of the source data back to the customer, or may send only a filtered version of some of the source data back to the customer, the rating service does not lose control of the source data, and a copy of the all of the source data cannot be made and distributed.

This invention provides a method and a system to provide a service to a customer over a network, such as the global Internet, where the service provides the customer access to a database. The method includes: (a) receiving a query from the customer, the query including a query program or an identification of a query program; (b) executing the query program in an environment that permits the query program to access at least a portion of the database, while selectively inhibiting transmission of information from the database; and (c) sending a response to the query, where the response includes a predetermined, limited amount of information that is returned as output by the query program. Executing the query program includes one of interpreting the query program or running a compiled version of the query program. The response may be sent to the customer or to a party designated by the query. Preferably the amount of information returned in the response to the query is limited to a predetermined number of data units. At least some access that the query program has to source data in the database may be available only in a summarized, pseudonymized, or otherwise filtered form of the source data, and/or at least some of the access that the query program has to source data in the database may be available only through a read process that performs a summarization, pseudonymization, or other filtering operation before presenting the source data to the query program. The query program may be received in an encrypted form, and may thereby not be exposed in an unencrypted form to a server that is coupled to the database. Receiving the query may also involve examining the query, and accepting the query program for execution only if at least one criterion is satisfied, where the criterion can be the absence of a known or suspected malicious program and/or a determination that the customer is financially responsible for the execution of the query program. Sending the response may involve examining the information that is returned as output by the query program, and the response may, in this case, be sent only if at least one criterion is satisfied. The criterion in this case can be that the information returned as output by the query program is equal to or less than some maximum number of data units. The query may further include information for specifying what data of the database is relevant to the query, and the environment then allows the query program to access only the specified data. In a presently preferred, but non-limiting embodiment, the system is a rating system for suppliers of at least one of goods and services, and the database stores data that is expressive of supplier performance for enabling a prediction of at least one supplier's performance to be made.

In a further aspect this invention provides a method to conduct a business over the Internet to provide a customer with an ability to analyze suppliers of goods and services. The method includes providing a database that stores supplier-related data; and in exchange for payment, provides a computer program, that is supplied or identified by the customer in a query received from the Internet, with access to the database. The method further executes the query program in an environment that permits the query program to access at least a portion of the database, while selectively inhibiting transmission of information from the database, and sends a response to the query. The response includes a predetermined, limited amount of information that is returned as output by the query program.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a simplified block diagram of a data processing system that is suitable for practicing this invention, where the system may include a performance-prediction server for electronic commerce applications;

FIG. 2 is a logic flow diagram illustrating the operation of a query-receipt process executed by the server shown in FIG. 1;

FIG. 3 is a logic flow diagram illustrating the operation of a query-execution process performed by the server shown in FIG. 1; and

FIG. 4 is a logic flow diagram illustrating the operation of a query-response process executed by the server shown in FIG. 1.

### DETAILED DESCRIPTION OF THE PREFERRED EMBODIMENTS

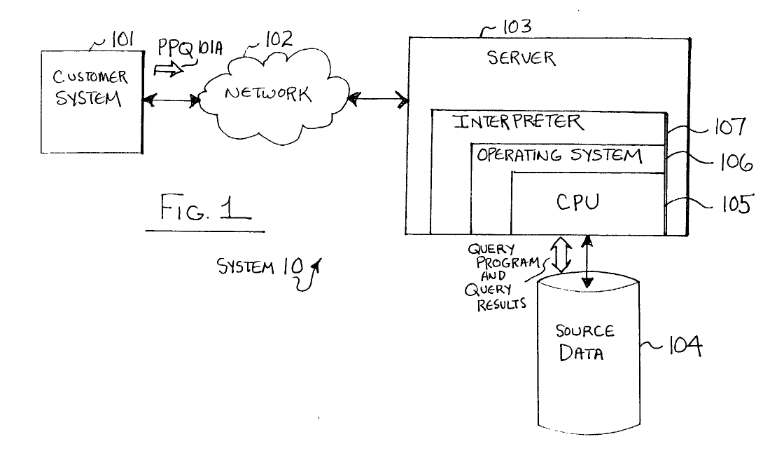

Referring to FIG. 1, a data processing system 10 includes at least one customer system 101 that is bidirectionally coupled to a server 103 through a network 102. The network 102 could be an intranet. a local area network (LAN), a wide area network (WAN), or the global Internet. In the referred embodiment of this invention the server 103 is located at or is associated with a performance-prediction service, and is adapted for executing performance-prediction tasks for electronic commerce applications. The teachings of this invention are not, however, limited for use only within this one important area, but may find use in other application areas as well.

In general, aspects of this invention can be used in any of a number of applications where there exists a repository of data having restricted access for some reason (e.g., because the data is proprietary, or is confidential or secret, or has intrinsic value), and where a third party program or some executable software agent is to be given access to the repository of data for at least one of examining the data, summarizing the data, searching the data, mining the data, organizing the data, or for any legitimate data processing purpose.

In FIG. 1 a performance-prediction query (PPQ) 101A is sent from the customer system 101, through the global Internet 102 to the server 103. The server 103 includes a central processing unit (CPU) 105, on which runs an operating system 106. In this embodiment an interpreter 107 runs above the operating system 106, and is capable of executing programs in an interpreted language, by providing a virtual machine environment using methods known to the art. The repository of data held by the performance-prediction service, referred to herein also as source data, is stored on computer-readable media 104, such as a fixed or removable disk drive, and/or an array of disk drives, and/or magnetic tape, and/or semiconductor-based memory.

In the presently preferred, but non-limiting embodiment the source data 104 is descriptive of suppliers of goods and/or services, and an analysis of the source data can thus be expected to yield an indication of the overall suitability or fitness of the various suppliers to perform their expected tasks, and to possibly enable a ranking of the various suppliers in one or more categories (e.g., cost, timeliness, support, etc.) As can be appreciated, the gathering and maintenance of the source data 104 may represent a considerable investment in time and money by the operator of the server 103, and the source data may thus be considered to be a valuable and proprietary asset of the operator of the server 103.

In other embodiments the source data 104 may be descriptive of other types of information. The other type of information may be, but is not limited to, governmental information, military information, scientific information and/or financial information. In any of these exemplary cases it assumed that the entity having control of the source data, referred to herein for convenience as a vendor, wishes to control access to and the export of data from the source data database or databases by the customer system 101.

The PPQ 101A is assumed to include some type of executable program or script or other software agent, referred to generically as a query program, that is operable to process the source data 104 according to criteria established by the customer system 101. While in general it may be the case that the executable program will be received as part of the PPQ 101A, in other embodiments the PPQ 101A may contain an identification of an executable customer program to be run, and the executable program may reside elsewhere, such as on the server 103, or at some other site. For example, a customer that makes frequent use of the service provided by the server 103 may have pre-stored one or more programs at the server 103, and simply identifies which program or programs should be run when sending the PPQ 101A. For the purposes of this invention, sending a program or programs with the PPQ 101A, and identifying one or more programs with the PPQ 101A, are logically equivalent operations, as the same result is obtained (i.e., execution of a desired one or more customer programs on the source data 104). The query program may also be one derived from, or supplied by, some third party.

The computer systems 101 and 103 may each be, by example, an IBM Intellistation™; and the central processing unit 105 may include, by example, an Intel Pentium™ class processor. The operating system 106 and interpreter 107 may be, by example, the Redhat build of GNU/Linux and the Sun Microsystems Java™ interpreter for Linux, respectively, or Microsoft Windows™ 2000 and the PythonLabs Python™ interpreter for Windows. In other embodiments of this invention, the network 104 may be a private local-area or wide-area network (LAN or WAN), a virtual private network (VPN) implemented over a public network by methods known in the art, or any other suitable network. These various embodiments are given as examples only, as those skilled in the art will recognize that other computer systems, networks, central processing units, operating systems, and interpreters may be substituted for those listed, and that all such substitutions will still fall within the scope of this invention.

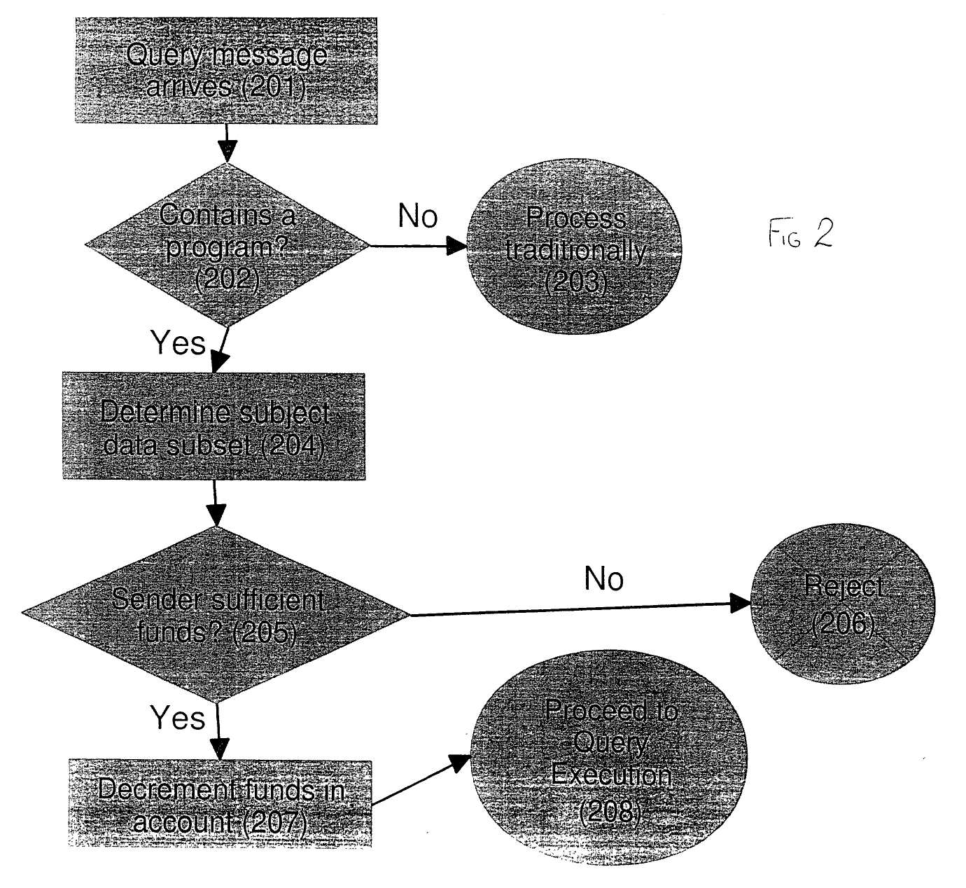

FIG. 2 illustrates a query-receipt process of this invention. The PPQ 101A sent from the customer system 101 is received by the server 103 in block 201. The server 103 inspects the PPQ 101A in block 202 to determine whether it contains (or identifies) a query program to be executed. If it does not, the query is processed by traditional methods in block 203. If the PPQ 101A does contain a query program to be executed, the server 103 examines the query program in block 204 to determine what sub-set of the source data 104 the query program requires access to. In general, the query program may require access to only a portion of the source data 104, or it may require access to all of the source data 104, depending on the nature and organization of the source data. In block 205 the server 103 verifies that the customer system 101 sending the PPQ 101A has sufficient funds on account to pay for the query that involves running the query program against the source data 104. If not, the PPQ 101A is rejected in block 206. If the customer system 101 does have sufficient funds on account, the account is decremented in block 207, and in block 208 the query program is passed to the query-execution process. In other embodiments of this invention, other charging and accounting schemes, such as a flat-rate subscription, a certain number of free queries per month, or charges only for successful queries, might be used. In general, the server 103 associated with the vendor makes a determination as to whether the customer system 101 is financially responsible for the execution of the query program.

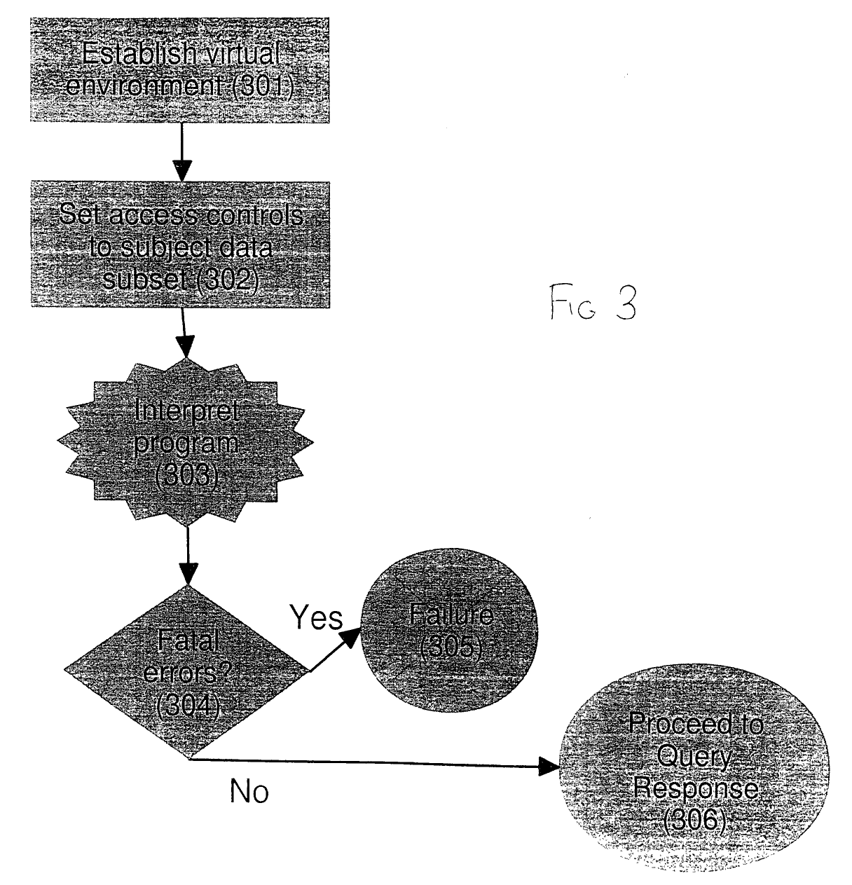

FIG. 3 illustrates the query-execution process. At block 301 the server 103 initializes the virtual environment and the virtual machine using conventional techniques. The query program is then loaded into the interpreter 107 in preparation for execution. At block 302 the server 103 configures access-controls in the virtual machine to allow access to the sub-set of the source data 104 that the PPQ 101A has requested. At block 303 the query program is interpreted in the virtual machine by the interpreter 107, in cooperation with the operating system 106 and the CPU 105, subject to the configured access controls. If a fatal error occurs during execution (block 304), the query program fails (block 305). Otherwise, the method proceeds at block 306 to the query-response process.

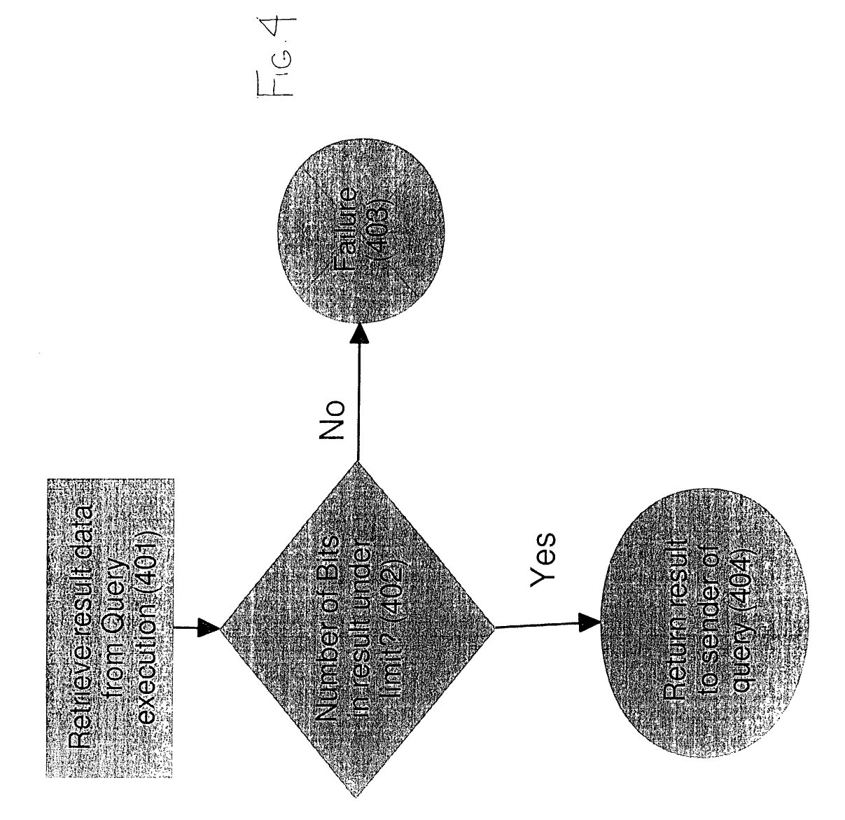

FIG. 4 illustrates the operation of the query-response process. At block 401 the result value generated by the execution at block 303 of the query program is retrieved. The size of the result value is tested at block 402, and if the value is larger than some threshold value the query fails at block 403. In other embodiments of this invention, a query response that is too large may simply be truncated to the maximum allowed size before being returned. In other embodiments of this invention a count may be kept of how many bits (or bytes, or records, or some other units of data) that the customer system 101 has obtained using a query program over some recent time interval, and a limit may be placed on the total. If the result value is smaller than the threshold, the data is returned to the customer system 101 at block 404. In other embodiments of this invention, the PPQ 10A may specify where the result should be returned, such as by designating a system or systems other than the customer system 101.

In some embodiments of this invention the query program potentially has read access to all of the available source data 104 held by the performance-prediction service embodied in the server 103. In other embodiments, the access of the query program is limited or filtered to protect proprietary source data, or any source data that is of such value that the performance-prediction service does not wish that even a controlled program have access to. It is within the scope of this invention that at least some of the access that the query program has to the source data 104, or other data, during the query-execution process is available only in a summarized, pseudonymized, or otherwise filtered form, or is available only through a read process that performs a summarization, pseudonymization, or other filtering operation before presenting the data to the query program. That is, in at least one embodiment no actual data is returned from the source data database, but only a processed form of the source data, such as a summary. In another embodiment only certain sub-sets of the source data 104 enable actual data to be returned, while other sub-sets allow only the summarized, pseudonymized, or otherwise filtered form of the source data 104 to be returned.

In many embodiments of this invention, including the embodiment described above, the algorithms used by the query program will be exposed to the performance-prediction service 103, as the performance-prediction service, actually the interpreter 107, is responsible for executing the algorithm(s). While in many cases this will be acceptable to the customer system 101, in some circumstances the customer system 101 sending the query program as part of the PPQ 101A may wish to protect the program's algorithm even from the performance-prediction service. One technique to accomplish this is to employ a mutually-trusted cryptographic co-processor (such as the IBM 4758 Cryptographic Co-Processor). Another technique is to produce an encrypted but still executable version of the program using techniques known to the art (see, for example, Sander and Tschudin, “Protecting mobile agents from malicious hosts”, in Mobile Agents and Security, LNCS 1419, Springer, 1998). A system using either of these techniques would operate in accordance with this invention.

In some embodiments of this invention it may be desirable to block certain query programs from being accepted for execution, and/or to prevent certain responses from being returned to the customer system 101, even if the response size is acceptable. For example, a performance-prediction service utilizing this invention may check incoming query programs for viruses or other malicious programs or program fragments, and reject any query programs that appear likely to contain such undesirable software entities. The performance-prediction service may also check the output of the program, and may not send the output back to the customer system 101 as a response if the output appears likely to contain information that the performance-prediction service does not wish to reveal, or if the amount of information exceeds some threshold amount of permissible information, as measured in data units.

While described above in the context of the interpreter 107 for executing the customer's query program, in other embodiments the customer's query program may be compiled, at the customer system 101 or at the server 103, and subsequently run in a controlled or protected mode by the operating system 106. In general, the query program could be expressed in, as examples, a general purpose programming language, a database query language, a proprietary program or query language (proprietary to the performance-prediction service 103), or in any suitable executable language.

Based on the foregoing description it should be apparent that an aspect of this invention is a computer program embodied on a computer-readable media, where the computer program provides a service to the customer system 101 over the network 102. The service provides access to the source data database 104 to a customer query program. Execution of the computer program results in the execution of a process to receive a query from the customer system 101, the query including the customer query program; execution of the customer query program in an environment that permits the query program to access at least a portion of the database while selectively inhibiting transmission of information from the database; and sends a response to the query, where the response contains a predetermined, limited amount of information that is returned as output by the query program.

While described in the context of a number of embodiments, this invention is not to be construed to be limited to only these embodiments, but should be viewed as encompassing as well all modifications in function and form to these embodiments as may be derived by those skilled in the art, when guided by the foregoing description and the appended drawing figures.

What is claimed is:

1. A method to provide a service to a customer over a network, the service comprising access to a database, comprising:
receiving a query from the customer, the query comprising one of a query program or an identification of a query program;
accepting the query program for execution only if at least one criterion is satisfied;
if accepted, executing the query program in an environment that permits the query program to access at least a portion of the database while selectively inhibiting transmission of information from the database; and
sending a response to the query, the response comprising a limited amount of information that is returned as output by the query program.

2. A method as in claim 1, where the response is sent to the customer.

3. A method as in claim 1, where the response is sent to a party designated by the query.

4. A method as in claim 1, where the amount of information that comprises the response to the query is limited to a predetermined number of data units.

5. A method as in claim 1, where at least some access that the query program has to source data in the database is available only in a summarized, pseudonymized, or otherwise filtered form of the source data.

6. A method as in claim 1, where at least some of the access that the query program has to source data in the database is available only through a read process that performs a summarization, pseudonymization, or other filtering operation before presenting the source data to the query program.

7. A method as in claim 1, where the query program is received in an encrypted form, and is not exposed in an unencrypted form to a server that is coupled to the database.

8. A method as in claim 1, where the system comprises a rating system for suppliers of at least one of goods and services, and where the database stores data that is expressive of supplier performance for enabling a prediction of at least one supplier's performance to be made.

9. A method as in claim 1, where the criterion comprises the absence of a known or suspected malicious program.

10. A method as in claim 1, where the criterion comprises a determination that the customer is financially responsible for the execution of the query program.

11. A method as in claim 1, where sending the response comprises examining the information that is returned as output by the query program, and sending the response only if at least one output criterion is satisfied.

12. A method as in claim 11, where the output criterion comprises the information returned as output by the query program being equal to or less than some maximum number of data units.

13. A method as in claim 1, where the query further comprises information for specifying what data of the database is relevant to the query, and where the environment allows the query program to access only the specified data.

14. A method as in claim 1, where the network comprises the global Internet.

15. A method as in claim 1, where the network comprises an intranet.

16. A method as in claim 1, where executing the query program comprises interpreting the query program.

17. A method as in claim 1, where executing the query program comprises running a compiled version of the query program.

18. A system to provide a service to a customer over a network, the service comprising access to a database, comprising a server coupled to the database and to the network for receiving a query from the customer, the query comprising one of a database query program or an identification of a database query program, said server comprising a computer for executing the query program in an environment that permits the query program to access at least a portion of the database while selectively inhibiting transmission of data from the database, said computer transmitting a response to the query to the network, the response comprising a limited amount of information that is returned as output by the query program, where the system comprises a rating system for suppliers of at least one of goods and services, where the database stores data that is expressive of supplier performance, and where the service provided to the customer comprises enabling a prediction of at least one supplier's performance to be made.

19. A system as in claim 18, where the response is transmitted to one of the customer or to a party designated by the query.

20. A system as in claim 18, where the amount of information that comprises the response to the query is limited to a predetermined number of data units.

21. A system as in claim 18, where at least some access that the query program has to source data in the database is available only in a summarized, pseudonymized, or otherwise filtered form of the source data.

22. A system as in claim 18, where at least some of the access that the query program has to source data in the database is available only through a read process that performs a summarization, pseudonymization, or other filtering operation before presenting the source data to the query program.

23. A system as in claim 18, where the query program is received in an encrypted form, and is not exposed in an unencrypted form to said server.

24. A system as in claim 18, where said server, in response to receiving the query, examines the query and accepts the query program for execution only if at least one criterion is satisfied.

25. A system as in claim 24, where the criterion comprises at least one of an absence of a known or suspected malicious program and a determination that the customer is financially responsible for the execution of the query program.

26. A system as in claim 18, where said computer, prior to transmitting the response, examines the information that is returned as output by the query program, and transmits the response only if at least one criterion is satisfied.

27. A system as in claim 26, where the criterion comprises the information returned as output by the query program being equal to or less than some maximum number of data units.

28. A system as in claim 18, where the query further comprises information for specifying what data of the database is relevant to the query, and where the environment allows the query program to access only the specified data.

29. A system as in claim 18, where the network comprises the global Internet.

30. A system as in claim 18, where the network comprises an intranet.

31. A system as in claim 18, where said computer, when executing the query program, one of interprets the query program or runs a compiled version of the query program.

32. A computer program embodied on a computer-readable media, said computer program providing a service to a customer over a network, the service comprising access to a database, execution of said computer program resulting in the execution of a process to receive a query from the customer, the query comprising one of a query program or an identification of a query program; to execute the query program in an environment that permits the query program to access at least a portion of the database while selectively inhibiting transmission of information from the database; and to send a response to the query, the response comprising a limited amount of information that is returned as output by the query program where the system comprises a rating system for suppliers of at least one of goods and services, where the database stores data that is expressive of supplier performance, and where the service provided to the customer further comprises enabling a prediction of the performance of at least one supplier to be made.

33. A method to conduct a business over the Internet to provide a customer with an ability to analyze suppliers of goods and services, comprising providing a database that stores supplier-related data; and in exchange for payment, providing a computer program, that is one of supplied or identified by the customer in a query received from the Internet, with access to the database; executing the computer program in an environment that permits the computer program to access at least a portion of the database while selectively inhibiting transmission of information from the database; and sending a response to the query, the response comprising a limited amount of information that is returned as output by the computer program and that enables a prediction of the performance of at least one supplier to be made.
